(19) United States
(12) Patent Application Publication
(10) Pub. No.: US 2021/0114586 A1
(43) Pub. Date: Apr. 22, 2021

(54) AUTONOMOUS DRIVING VEHICLE PARKING DETECTION

(71) Applicants: Ralf Graefe, Haar (DE); Rafael Rosales, Unterhaching (DE)

(72) Inventors: Ralf Graefe, Haar (DE); Rafael Rosales, Unterhaching (DE)

(21) Appl. No.: 17/133,121

(22) Filed: Dec. 23, 2020

(51) Int. Cl. B60W 30/06; G08G 1/14

(52) U.S. Cl. CPC B60W 30/06; G08G 1/14; B60W 2554/4044; B60W 2554/801; B60W 2554/802; B60W 2552/00; B60W 2552/50; B60W 2554/4043; B60W 2554/4045; B60W 2540/10; B60W 2540/12; B60W 2552/53; B60W 2554/4042

(57) ABSTRACT

Systems and methods for automated driving vehicle parking detection are described herein. The systems and methods are directed to detecting an available space, the available space comprising a space dimension larger than the automated driving vehicle, detecting a road marker associated with the available space, and determining that the available space is not a parking space based on the road marker and the space dimension. The systems and methods are also directed to guiding the automated driving vehicle to park in the available space in response to determining that the available space is not the parking space, and activating an occlusion prevention subsystem.

### BACKGROUND

Automated vehicles are developed to automate, adapt, or enhance vehicle driving capabilities with limited human intervention. When parking, automated driving vehicles can maneuver into a designated parking space, drive around continuously, or return home. In populated areas, the majority of the curbs and side streets appear available as parking spaces to the sensors attached to the automated vehicles, but are actually unavailable for parking due to the ingress and egress access points from buildings or structures that must be kept clear or due to parking signage, hazard zones, or private property. These impermissible parking areas must remain freely accessible in order for cars, trucks, and other moving objects to move in and out of the designated area.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of an automated driving vehicle and occlusion prevention subsystem, in accordance with some examples.

FIG. 2A-2C are illustrations of the automated driving vehicle detecting approaching vehicles in accordance with some examples.

FIG. 3A-3B are illustrations of approaching vehicles requesting entrance into a building in which the automated driving vehicle blocking in accordance with some examples.

FIG. 4 is an illustration of corridor angle trajectories of approaching vehicles within the vicinity of the automated driving vehicle in accordance with some examples.

FIG. 5 is a flowchart illustrating a method 500 for the automated driving vehicle to detect an available parking space in accordance with some examples.

FIG. 6 is a flowchart illustrating a method 600 for the automated driving vehicle to detect, and move away from a parking space in accordance with some examples.

FIG. 7 is a flowchart illustrating a method 600 for the automated driving vehicle to detect and move away from a parking space using tarmac signage and a plausibility check, in accordance with some examples.

FIG. 8 is a diagrammatic representation of an automated driving vehicle and occlusion prevention subsystem using a centralized software platform, in accordance with some examples.

FIG. 9 is a diagrammatic representation of a machine in the form of a computer system within which a set of instructions may be executed for causing the machine to perform any one or more of the methodologies discussed herein, in accordance with some example embodiments.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

As the rise in automated driving vehicles become increasingly popular, automated vehicles can now fully drive themselves without human interaction. Automated driving vehicles (ADVs) have no need to park close to their destination, or even permanently park at all. Instead, ADVs can seek out free on-street parking, return home, or cruise (circle around). The suggested course of action here is to modernize the idea of parking to also include empty cruise time. These solutions do not resolve issues of energy consumption and road congestion by the ADVs as they cruise around various areas while searching (or idling) for a parking space.

In both rural and urban areas, empty spaces that are not officially designated as available parking spaces can in fact be utilized as temporary parking spaces for ADVs. These empty spaces include curbs and side streets that intersect with a driveway, walkway, or pathway and also, open areas that have been designated as “non-parking” by an authorized parking official, municipality, or private property owner. For curbs and side streets that intersect with a driveway, walkway, or pathway, the issue arises when the ADV parks in an unavailable parking space, the ADV obstructs the exit or entrance of moving objects, such as cars, motorcycles, bicycles, or any other objects, essentially restricting the flow of the moving objects and preventing them from exiting or entering an area due to the parked ADV blocking the passage of the driveway.

In at least one example, a system is provided that enables an ADV to unilaterally identify an empty space, that may or may not be available, on a roadway and instruct the ADV to park into the parking space and drive away from the parking space when moving objects approach. For instance, using on-board sensors, the system verifies the physical dimensions of the curb, the roadway marker on the roadway, the curb type, parked vehicles and other structural characteristics within the vicinity of the empty space, and when the empty space has been verified, the system autonomously parks the ADV into the empty space, which can be in front of a driveway meant for ingress and egress by other vehicles. While the ADV is parked in the empty space, the system identifies when another vehicles, objects, or moving objects are approaching and immediately reacts by moving the ADV out of the empty parking space in order to allow the moving object to enter or exit the driveway.

In another example, the system can communicate with a central management platform application in order to determine which parking spaces within a selected area have been designated as available and/or unavailable parking spaces. The system uses the information from the central management platform to identify places and hours where the ADV can park and autonomously move away based on the information. In another example, while the ADV is parked in the empty space, the system can also receive requests from other vehicles, such as non-ADVs, governmental vehicles, or emergency vehicles, to vacant the empty space based on detecting hazard lights, headlight flashes, and other traffic indicators emitted from the approaching vehicle.

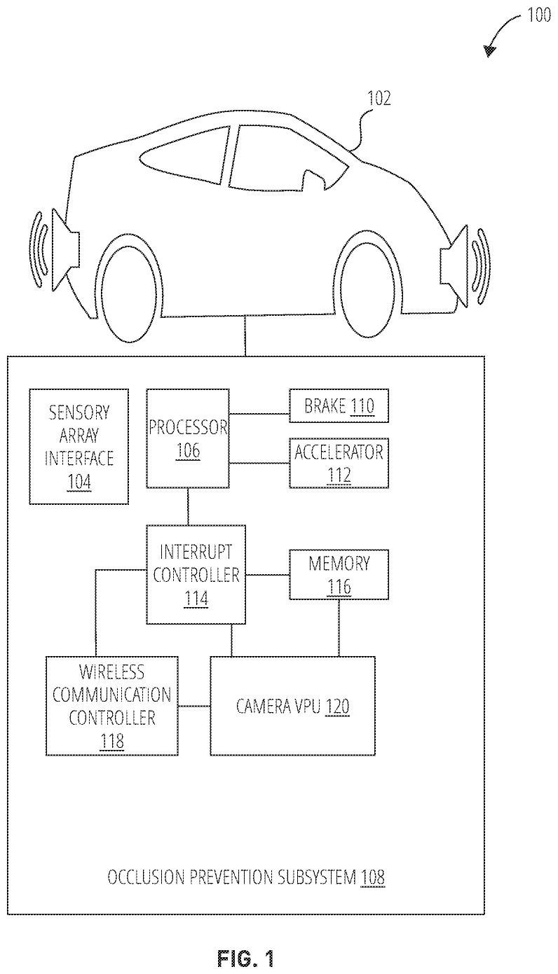

FIG. 1 is a diagrammatic representation 100 of an automated driving vehicle (ADV) 102 and occlusion prevention subsystem 108, in accordance with some examples. As shown in FIG. 1, the occlusion prevention subsystem 108, which includes a sensory array interface 104, processor 106, brake 110, accelerator 112, interrupt controller 114, memory 116, wireless communication controller wireless communication controller 118, incorporated into the ADV 102. The ADV 102 may be of any type of vehicle, such as a commercial vehicle, a consumer vehicle, a recreation vehicle, a car, a truck, a motorcycle, or a boat, able to operate at least partially in an autonomous mode.

The ADV 102 may operate at in a manual mode where the driver operates the ADV 102 conventionally using pedals, including the brake pedal and acceleration pedal, steering wheel, and other controls. At other times, the ADV 102 may operate in a fully autonomous mode (e.g., the ADV 102 operating without user intervention). In addition, the vehicle 104 may operate in a semi-autonomous mode (e.g., where the vehicle 104 controls many of the aspects of driving, but the driver may intervene or influence the operation using conventional steering wheel and non-conventional inputs such as voice control).

The ADV 102 includes a sensory array interface 104, which may include various forward, side, and rearward facing cameras, radar. LIDAR, ultrasonic, or similar sensors. Forward-facing is used in this specification to refer to the primary direction of travel, the direction the seats are arranged to face, the direction of travel when the transmission is set to drive, or the like. Rear-facing or rearward-facing is used to describe sensors that are directed in a roughly opposite direction than those that are forward or front-facing. It is understood that some front-facing camera may have a relatively wide field of view, even up to 180-degrees.

Similarly, a rear-facing or front facing camera that is directed at an angle (perhaps 60-degrees off center) to be used to detect traffic or approaching vehicles in adjacent traffic lanes or within the vicinity of the ADV 102, may also have a relatively wide field of view, which may overlap the field of view of the front-facing camera. Side-facing sensors are those that are directed outward from the sides of the vehicle. Cameras in the sensor array may include infrared or visible light cameras, able to focus at long-range or short-range with narrow or large fields of view.

Further, the ADV 102 includes an on-board diagnostics system to record vehicle operation and other aspects of the vehicle's performance, maintenance, or status. The ADV 102 may also include various other sensors, such as driver identification sensors (e.g., a seat sensor, an eye tracking and identification sensor, a fingerprint scanner, a voice recognition Module, or the like), occupant sensors, or various environmental sensors to detect wind velocity, outdoor temperature, barometer pressure, rain/moisture, or the like.

Components of the occlusion prevention subsystem 108 may communicate using a network, which may include local-area networks (LAN), wide-area networks (WAN), wireless networks (e.g., 802.11 or cellular network), the Public Switched Telephone Network (PSTN) network, ad hoc networks, personal area networks (e.g., Bluetooth), vehicle-based networks (e.g., Controller Area Network (CAN) BUS), or other combinations or permutations of network protocols and network types. The network may include a single local area network (LAN) or wide-area network (WAN), or combinations of LANs or WANs, such as the Internet. The various devices coupled to the network may be coupled to the network via one or more wired or wireless connections.

In operation, the ADV 102 detects sensory information via sensory array interface 104 from forward-facing sensors to detect an object, moving object, structural characteristics, traffic signage, road markings, curb types, curb dimension information, or potential collision hazard. The forward-facing sensors may include radar, LIDAR, visible light cameras, or combinations. Radar is useful in nearly all weather and longer range detection, LIDAR is useful for shorter range detection, cameras are useful for longer ranges but often become less effective in certain weather conditions, such as snow. Combinations of sensors may be used to provide the widest flexibility in varying operating conditions.

In one example, based on the sensory information, a processor 106 integrated in the occlusion prevention subsystem 108 includes machine learning algorithmic programming that enables the system to detect an empty space, such as a parking space with a curb and size and space dimensions, detect roadway markers associate with the parking space, determine that the parking space is available or unavailable based on the roadway markers, execute plausibility checks (discussed below), determine whether a possible collision may occur, instruct communication with a third party application, such as a centralized platform, identify and detect approaching objects. Based on this determination, the occlusion prevention subsystem 108 may initiate braking of the ADV 102 and/or automated guiding into the parking space by utilizing the brake 110 and acceleration operations of the brake 110 and accelerator 112. The processor 106 interfaces with interrupt controller 114, brake 110, and accelerator 112 to initiate autonomous detection and moving of the ADV 102 according to the configuration of the occlusion prevention subsystem 108.

Still referring to FIG. 1, the interrupt controller 114 is configured to operate on interrupt signals from the wireless communication controller 118 or a forward-facing, backward-facing, or side-facing camera vision processing unit (Camera VPU) 120. Vehicular communication systems, such as vehicle-to-vehicle (V2V) and infrastructure-to-vehicle (I2V) communication paradigms, can be used for use with cooperative intelligent transport systems (ITS) integrated into the ADV 102. These systems may extend the visibility range of vehicles beyond what expensive sensors mounted onboard vehicles may achieve. Cooperative ITS may be implemented using Dedicated Short Range Communications (DSRC) or cellular-based communication (e.g., LTE).

As such, the wireless communication controller 118 may be a 4G or 5G wireless controller or other radio-based controller to support vehicle-to-vehicle (V2V), vehicle-to-infrastructure (V2I), vehicle-to-anything (V2X), or other types of communication. The wireless communication controller 118 may be in communication with other vehicles on the roadway, a centralized platform application, cloud-based databases, or other static installations, such as radio towers, roadside monitors, smart traffic lights, or emergency personnel.

In one example, the camera VPU 120 is used to detect, capture, and analyze images, content, structures, objects, vehicles, and other imagery detected from one or more forward-facing, side-facing, or backward-facing cameras. When the camera VPU 120 is used to detect, capture, and/or analyze an empty space, a moving object approaching the ADV 102, structural characteristics, a roadway marker, a general hazard in the road or other potential hazard, or a traffic indicator, the wireless communication controller 118 asserts one or more specific interrupts to signal the interrupt controller 114. As one or more interrupts are asserted, the processor 106 reads status registers or memory (e.g., from memory 116), to obtain further information about the interrupt. The processor 106 executes rules and routines to determine an appropriate response.

In some examples, responses include, but are not limited to, guiding the ADV 102 into a parking space, initiating an application of brakes with a braking force, initiating an actuated force of acceleration of the ADV 102 and guiding the ADV 102 in the direction away from the parking space, alerting a driver of the ADV 102 of the unavailability of a parking space or incapability of the parking space dimensions for the ADV 102. In one example, the actuated force of acceleration represents automatically or autonomously activating the accelerator 112 and other structural components of the ADV 102 to drive, move, guide, and accelerate the ADV 102 in a direction. In another example, initiating an application of brakes represents applying the ADV 102 parking brake 110. The braking force represents the force applied to the brake 110 by a driver (if in manual mode) or autonomously (e.g., by the ADV 102 to autonomously slow or stop the vehicle). Additionally, the processor 106 may transmit a signal using the wireless communication controller 118 to receive traffic and parking space availability and unavailability information from the centralized platform application.

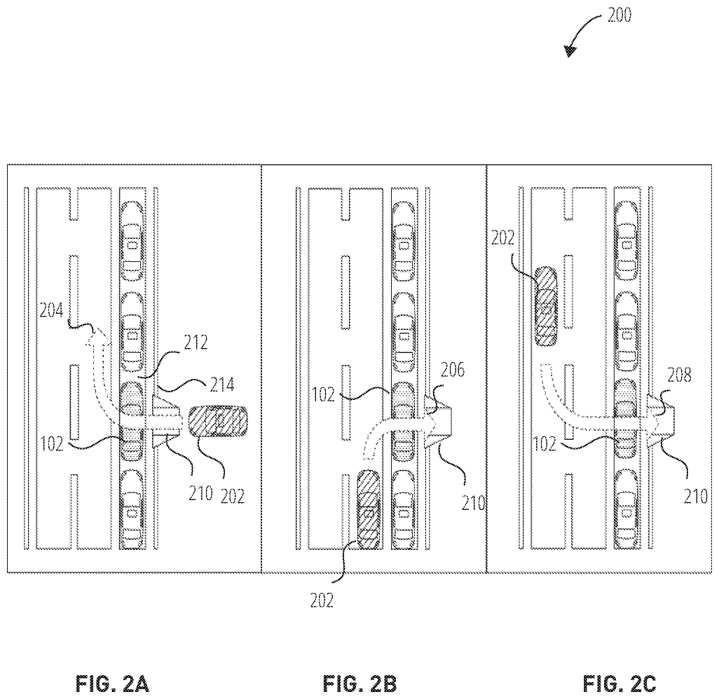

FIGS. 2A-2C are illustrations of the ADV 102 detecting approaching vehicles in accordance with some examples. As shown in FIG. 2A, the ADV 102 detects an open available space 212, which includes an adjacent curb 214 and road marker 210. The ADV 102 determines that the available space 212 is an unavailable parking space by determining that the curb 214 is an open intersection curb where other vehicles can actively exit and enter from and the road marker 210 indicates that the available space 212 is also unavailable due to the layout of the curb 214 (e.g., designed for ingress and egress). While the ADV 102 is parked in available space 212, an approaching vehicle 202 is moving in the direction of ADV 102, for instance, a heading of the approaching vehicle 202 is pointing directly in a direction of the ADV 102 in an attempt to exit the curb 214. The ADV 102, in communication with the sensory array interface 104, detects the distance between the approaching vehicle 202 and the ADV 102, detects the size of the approaching vehicle 202, and detects the heading of the approaching vehicle 202. As the approaching vehicle 202 moves closer to the ADV 102, the ADV 102, via the occlusion prevention subsystem 108, initiates the actuated force of acceleration and guides the ADV 102 in a direction 204 away from the available space 212. In another example, the occlusion prevention subsystem 108 detects a distance between the approaching vehicle 202 and ADV 102 and determines that the distance between the approaching vehicle 202 (e.g., moving object) and the ADV 102 exceeds or is less than a first threshold value. In some examples, the first threshold value can be any value measured in metric units, such as millimeters, centimeters, meters, kilometers. The threshold value can also be measured in inches or feet (length). For example, the first threshold value represents the length of two vehicles, e.g. 15 feet. When the distance between the approaching vehicle 202 and the ADV 102 is less than 15 feet, the occlusion prevention subsystem 108, initiates the actuated force of acceleration and guides the ADV 102 in a direction 204 away from the available space 212. In other examples, the occlusion prevention subsystem 108 assigns multiple threshold values associated with the distance between the approaching vehicle 202 and ADV 102.

In another example, the occlusion prevention subsystem 108, upon activation, detects a moving object approaching from a direction toward the automated driving vehicle. The moving object includes a heading as described above. The occlusion prevention subsystem 108 determines that the heading of the moving object is pointing toward the automated driving vehicle, along with a distance between the moving object and the automated driving vehicle. If the distance between the moving object and the automated driving vehicle is less than the threshold value, the occlusion prevention subsystem 108 initiates an actuated force of acceleration of the automated driving vehicle and guides the automated driving vehicle in the direction away from the available space. For example, the occlusion prevention subsystem 108 moves the vehicle out of the available space or away from the available space.

As shown in FIG. 2B, while the ADV 102 is parked in available space 212, an approaching vehicle 202 is moving in the direction of ADV 102, but from the rear section of the ADV 102. For instance, a heading of the approaching vehicle 202 is pointing directly to the rear direction of the ADV 102 in an attempt to enter the curb 214. The ADV 102, in communication with the sensory array interface 104, detects various autonomous guiding factors, such as, the speed of the approaching vehicle 202, the traffic indicators of the approaching vehicle 202 (e.g., turn signal, headlights, headlight flashing sequences, or hazard lights), the lane location of the approaching vehicle 202, or the distance between the approaching vehicle 202 and the ADV 102. Each of the autonomous guiding factors are assigned a threshold value (e.g., 1=yes, 0=no). Once the threshold value is exceeded past a predetermined value, such as 2 or greater, the occlusion prevention subsystem 108 initiates an actuated force of acceleration and guides the ADV 102 in a direction 204 away from the available space 212.

In FIG. 2C, as the ADV 102 is parked in available space 212, an approaching vehicle 202 is moving in a driving direction 208 from the opposite lane of ADV 102. For instance, the approaching vehicle 202 is attempting to make a left turn into the curb 214, however, the ADV 102 is blocking passage into the curb 214. The ADV 102, in communication with the sensory array interface 104, detects autonomous guiding factors of the approaching vehicle 202 in FIG. 2C, such as, the speed of the approaching vehicle 202, the traffic indicators of the approaching vehicle 202 (e.g., turn signal, headlights, or hazard lights), the lane location of the approaching vehicle 202, or the distance between the approaching vehicle 202 and the ADV 102.

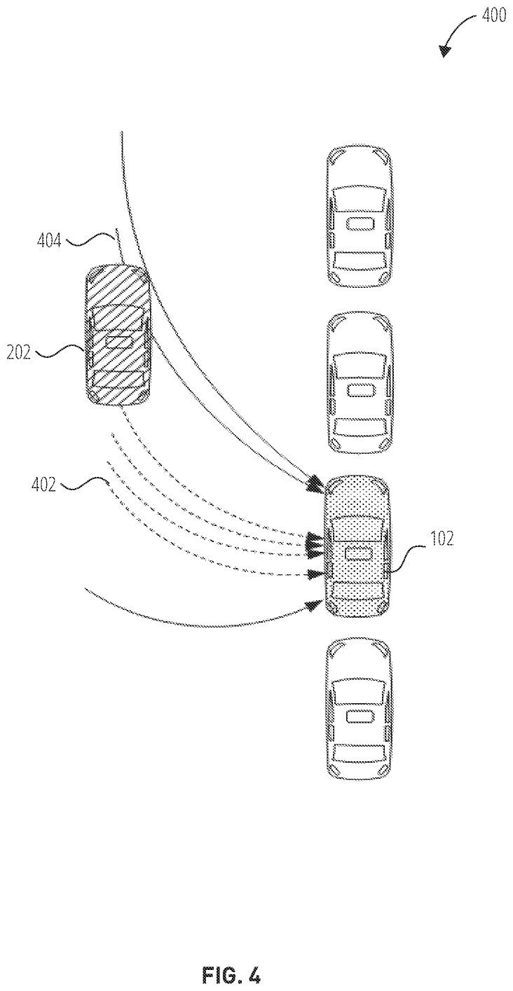

Still referring to FIG. 2C, each of the autonomous guiding factors are assigned a threshold value (e.g., 1=yes, 0=no). The occlusion prevention subsystem 108 also determines a corridor angle trajectory (explained in detail in FIG. 4) associated with the approaching vehicle 202 and the ADV 102 parked in available space 212. In one example, the corridor angle trajectory represents one or more angles of realistic trajectory turning circles of the approaching vehicle 202 and the total length of the trajectory converging to a 90 degree angle in relation to a main driving direction of the road. Once one or more corridor angle trajectories are determined and the threshold value of the autonomous guiding factors exceed a predetermined value, such as 2 or greater, the occlusion prevention subsystem 108 initiates the actuated force of acceleration and guides the ADV 102 in a direction 204 away from the available space 212, away from structural characteristic 302, or away from any area the ADV 102 is parked in a stationary location in which an approaching vehicle 202 is attempting to move into, enter or exit.

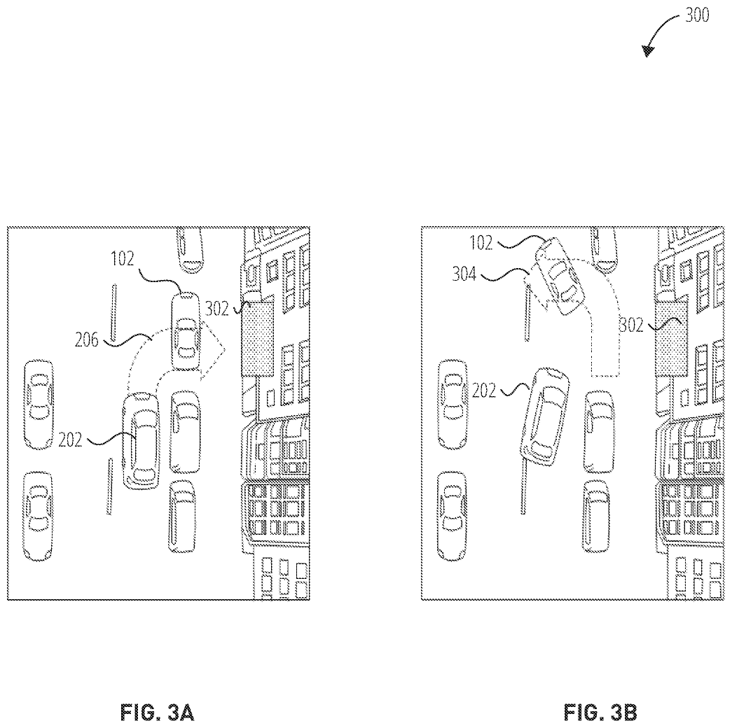

FIG. 3A-3B are illustrations of approaching vehicles requesting entrance into a building in which the automated driving vehicle blocking in accordance with some examples. As shown in FIG. 3A, the approaching vehicle 202 moves into the direction of the parked ADV 102 from the rear, while the ADV 102 is parked in available space 212. For instance, a heading of the approaching vehicle 202 is pointing at the rear direction of the ADV 102 in an attempt to enter a building structure with structural characteristic 302. The structural characteristic 302 represents the type of building, the size of building, the type of building exit and entrance, and other structural surroundings within the vicinity of the ADV 102. The ADV 102, in communication with the sensory array interface 104, detects the autonomous guiding factors, such as, the speed of the approaching vehicle 202, the traffic indicators of the approaching vehicle 202 (e.g., turn signal, headlights, or hazard lights), the lane location of the approaching vehicle 202, or the distance between the approaching vehicle 202 and the ADV 102.

Still referring to FIG. 3A, the approaching vehicle 202 is emitting traffic indicators as it approaches the ADV 102 from the rear. The ADV 102 detects the traffic indicators from the approaching vehicle 202 via the sensory array interface 104. In one example, the traffic indicators captured by the ADV 102 from the approaching vehicle 202 represent flashing headlights, flashing hazard lights, emergency personnel flashing lights and sirens, horns, or other visual and auditory signals. Each of the traffic indicators, including any other autonomous guiding factors, are assigned a threshold value (e.g., 1=yes, 0=no).

As shown in FIG. 3B, the occlusion prevention subsystem 108 determines that the threshold value of each detected traffic indicators has exceeded past a predetermined value of 0 (e.g., 0=no detection of traffic indicators or autonomous guiding factors). As such, the occlusion prevention subsystem 108 initiates an actuated force of acceleration and guides the ADV 102 in a left direction 304 away from the structural characteristic 302 in order for the approaching vehicle 202 to drive into the structural characteristic 302.

FIG. 4 is an illustration of valid and invalid corridor angle trajectories of approaching vehicles within the vicinity of the automated driving vehicle in accordance with some examples. As the approaching vehicle 202 moves into a direction in which the ADV 102 is blocking the entrance or exit of a structural characteristic 302, the occlusion prevention subsystem 108 generates a series of corridor angle trajectories. The series of corridor angle trajectories include valid and invalid corridor angle trajectories. In one example, a corridor angle trajectory represents one or more angles of realistic trajectory turning circles of the approaching vehicle 202 and the total length of the trajectory converging to a 90 degree angle in relation to a main driving direction of the road.

The phrase “realistic trajectory” represents the angle in which the approaching vehicle 202 can reasonable use to turn into a parking space, structural characteristic, or empty space based on the location of the ADV 102 and the length of the approaching vehicle 202, the size of the approaching vehicle 202, and the speed of the approaching vehicle 202. The evaluation of the corridor angle trajectory that an approaching angle of the vehicle will converge to 90 in relation to the main driving direction of the road in order to minimize time and distance for crossing the road. As shown in FIG. 4, the valid corridor angle trajectory 404 represents the angular trajectory that the approaching angle of the vehicle will converge to 90° angle based on the driving direction of the roadway.

In another example, the valid corridor angle trajectory 404 represents a turning diameter orthogonal to a 90° angle associated with the automated driving vehicle. Once the ADV 102 determines that the corridor angle trajectory 404 is valid, the occlusion prevention subsystem 108 initiates the actuated force of acceleration of the ADV 102. The occlusion prevention subsystem 108 also determines invalid corridor angle trajectory 402. After determining invalid corridor angle trajectory 402, the occlusion prevention subsystem 108 instructs the ADV 102 to remain parked or in a static (e.g., still) state. In another example, after determining invalid corridor angle trajectory 402, the occlusion prevention subsystem 108 instructs the ADV 102 to initiate an application of brakes with the braking force.

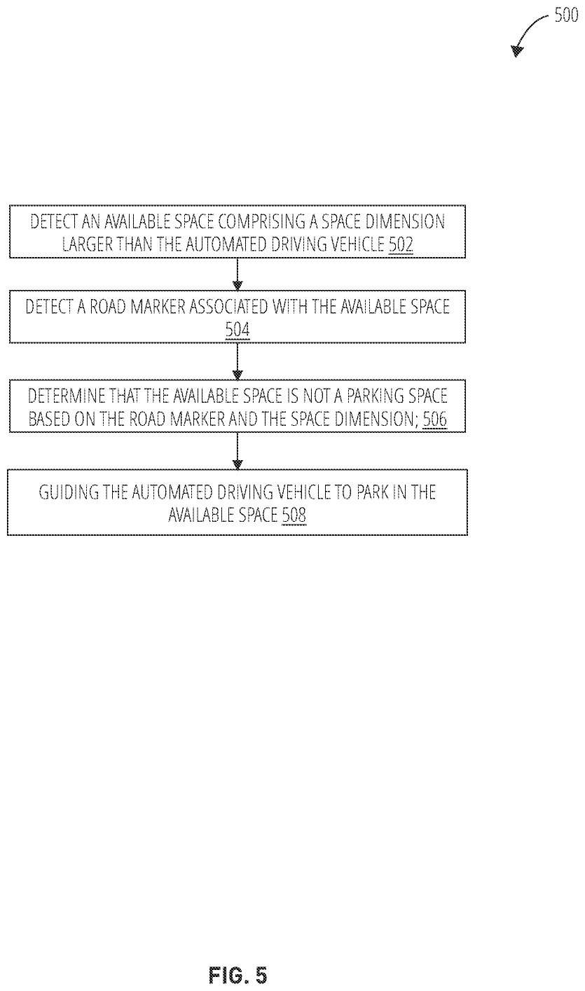

FIG. 5 is a flowchart illustrating a method 500 for the automated driving vehicle to detect an available parking space in accordance with some examples. While certain operations of the method 500 are described as being performed by certain devices, in different examples, different devices or a combination of devices may perform these operations. For example, operations described below as being performed by the client device 102 may also be performed by or in combination with server-side computing device, a third-party server computing device, or a computing devices integrated into an automated driving vehicle.

The method commences with operation 502, during which the occlusion prevention subsystem 108, via the sensory array interface 104, detects a parking space, the parking space includes a curb and a space dimension. The space dimensions represents space characteristics including the width, length, and depth dimensions of the parking space. As with a parking space, an open area, empty space, or the like can also be detected. In another example, the space dimension is an area that is larger than the ADV 102.

In operation 504, the occlusion prevention subsystem 108 detects a roadway marker associated with the parking space. In one example, the roadway marker is a visual layout overlaid on the roadway representing a combination of words, shapes, or polygonal arrangements that indicate available and non-available parking spaces. The roadway marker can also include road markings associated with a permissible parking space, a series of signs, and various forms of signage within the proximity of the detected parking space. In operation 506, the occlusion prevention subsystem 108 determines that the parking space is available based on the roadway marker and the space dimension.

The sensory array interface 104 verifies the suitability of an empty parking space or area for parking by recognizing the dimensions of the parking space, parked vehicles within the immediate vicinity of the parking space, walkways and pathways around the parking space, the curb type, and other structural characteristics within the vicinity or area near the detected parking space. In response to determining that the parking space is available based on the roadway marker and the space dimension, the occlusion prevention subsystem 108 continues with operation 508, in which the occlusion prevention subsystem 108 guides the automated driving vehicle into the parking space and initiates the application of brakes with the braking force (e.g., parks the car into the parking space).

In some examples, the occlusion prevention subsystem 108 communicates with a computing device and retrieves and transmits the parking space characteristics to the computing device. The computing device includes a third party server or client computing device integrated into an automated driving vehicle. In one example, the occlusion prevention subsystem 108 communicates with a centralized management platform application (e.g., MOOVIT®) in order to retrieve space availability information and parking space occupancy data representing the specified area, time, and location of parking spaces or empty spaces that a non-automated vehicle (or automated vehicle) is prohibited from using. For instance, a parked vehicle or a house owner may input to the platform that his vehicle or garage entrance is typically not used from 9:20 am until 4:30 pm. Automated vehicles may then use this service to identify places and hours where they could park and autonomously move away if needed (in-front of garage or in 2nd row). The occlusion prevention subsystem 108 receives parking space occupancy data, from the computing device, based on the parking space characteristics and determines that the parking space is unavailable based on the parking space occupancy data. In response determining that the parking space is unavailable, the occlusion prevention subsystem 108 guides the automated driving vehicle in a direction away from the parking space.

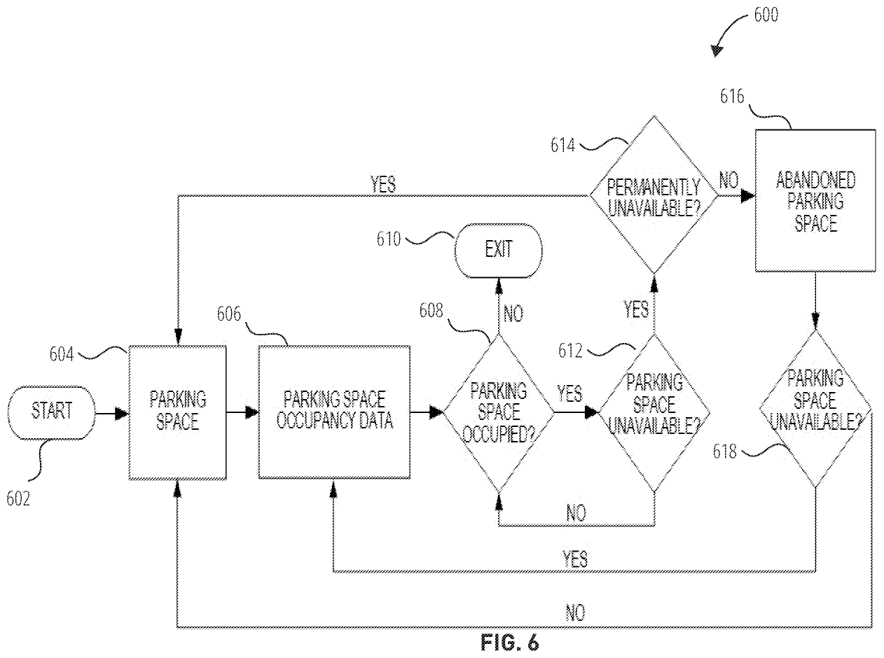

FIG. 6 is a flowchart illustrating a method 600 for the automated driving vehicle to detect, and move away from a parking space in accordance with some examples. The processor 106 is integrated in the occlusion prevention subsystem 108 and includes machine learning algorithmic programming that enables the system to execute operations illustrated in method 600. In one example, the processor 106 instructs the sensory array interface 104 to detect and select an available parking space 604 for an automated vehicle, e.g., ADV 102 and retrieve parking space occupancy data 606.

In another example, after detecting an available parking space, the processor 106, after receiving user input, transmits and registers the parking space occupancy data with a third party application stored on a third party computing device, e.g., MOOVIT®, as well as, space registration information regarding the available parking space. In one example, space registration information represents the specified area, time, dimensions, and location of parking spaces or empty spaces that a non-automated vehicle (or automated vehicle) is prohibited or allowed to use.

The processor 106 determines, via the sensory array interface 104, if the detected parking space is occupied 608 by another vehicle or object. If the detected space is occupied, the processor 106 instructs the ADV 102 via the accelerator 112 and brake 110 to exit 610 (e.g., guide or drive away from the occupied space). If the processor 106, via the sensory array interface 104 or based on receiving parking space occupancy data from the third party application, determines that the parking space 608 is not occupied 612, the processor 106 determines if the space is permanently unavailable 614.

As further shown in FIG. 6, if the parking space is permanently unavailable, the processor 106 instructs the ADV 102 to abandon the parking space 616. The method 600 continues with determining that the same parking space is available or unavailable 618. In one example, a second user of a second computing device can transmit a signal to the third party application requesting to update, modify, or register available space occupancy information regarding the selected or non-selected parking space within a certain region. If the status of the availability of the parking space has changed to “available,” then the processor instructs retrieves parking space occupancy data 606 and reinitiates the method 600.

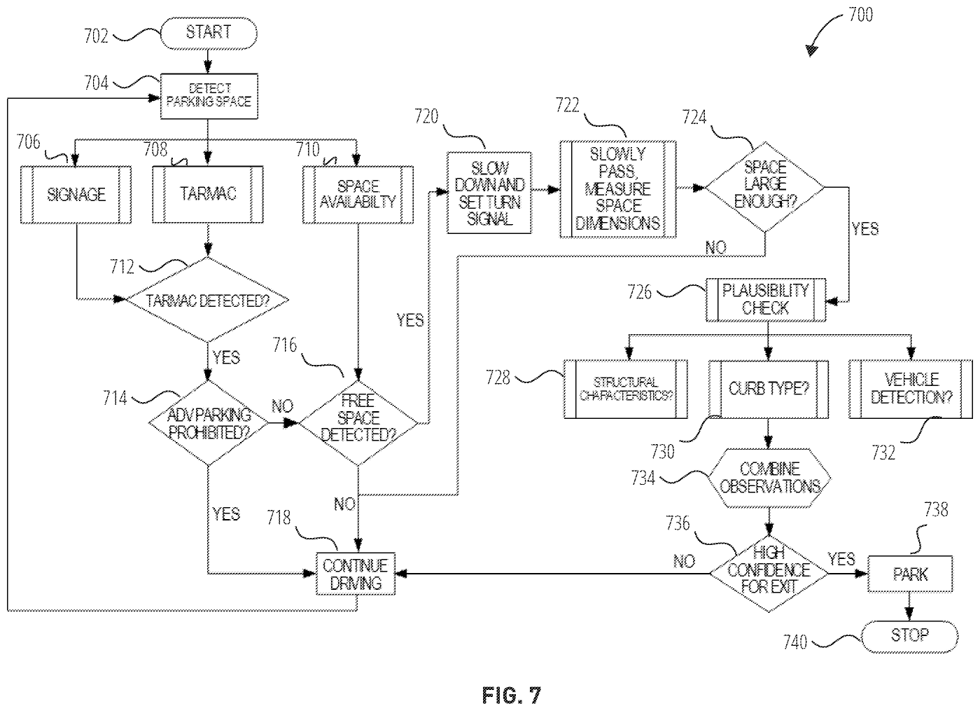

FIG. 7 is a flowchart illustrating a method 600 for the automated driving vehicle to detect and move away from a parking space using tarmac signage and a plausibility check, in accordance with some examples. The processor 106 is integrated in the occlusion prevention subsystem 108 and includes machine learning algorithmic programming that enables the system to execute operations illustrated in method 700. In one example shown in FIG. 7, method 700 starts with decision block 700. The processor instructs the ADV 102 to detect, via the sensory array interface 104, a parking space 704.

Upon detecting a parking space 704, the processor determines signage 706, roadway markers 708, and parking space availability 710. In one example, the roadway marker is a visual layout overlaid on the roadway representing a combination of words, shapes, or polygonal arrangements that indicate available and non-available parking spaces. The roadway marker can also include road markings associated with a permissible parking space, a series of signs, and various forms of signage within the proximity of the detected parking space. The signage represents traffic signs, banners, illustrations, or traffic imagery that indicates available or unavailable parking spaces, hazards, or road conditions, roadway markers also include a unique symbol indicating that the ADV 102 can move away autonomously, a machine readable code (e.g., barcode or QR image), or cleartext instructions directed to how to approach and signal the ADV 102 to move into the available parking space.

The processor 106 includes specialized circuit which includes a tarmac signage detection algorithm based on a machine learning algorithm specifically designed to recognize new road markings and detect explicitly allowed parking locations. At decision block 712, if roadway markers are detected, the processor 106 determines whether the ADV 102 is prohibited from parking in the detected space via the processes utilizing the sensory array interface 104 as discussed above or by communicating with the third party application. e.g., centralized management platform. In decision block 714, if the ADV 102 is prohibited from using the parking space, the ADV 102 will continue to drive in search for another available parking space.

If the ADV 102 is permitted to use the parking space, it is considered a free space detected 716 and the ADV 102 is instructed via the processor 106 to slow down and activate the turn signal 720. Upon executing decision block 720, the ADV 102 slowly passes and captures parking space dimensions. e.g., width, length, depth of the parking space 722. If the ADV 102 determines, via the processor 106 and sensory array interface 104 that the parking space dimensions do not correspond with the size of the ADV 102, the ADV 102 will continue to drive in search for another available parking space. If the ADV 102 determines, via the processor 106 and sensory array interface 104, that the parking space dimensions correspond with the size of the ADV 102, the processor 106 executes a plausibility check algorithm.

The plausibility check algorithm is based on a machine learning algorithm and is designed to determine the structural characteristic of the area surrounding or within the immediate vicinity of the parking space (block 728), the curb type and size (block 730), and vehicles parked within the vicinity of the detected parking space (block 732). A free-space detection algorithm is further utilized to detect vehicles that are just about to approach or leave through the detected curb type.

In one example, the plausibility check machine learning algorithm is designed to recognize the appearance of different exits and entrances from buildings, stores, schools, or compounds (structural characteristics). A measurement algorithm using data from the sensory array interface 104 detects the depth measurements (e.g., radar. LIDAR, stereo cameras, or a combination thereof) to identify the shape of the curb. The curb type that is determined by the plausibility check 726 corresponds to detecting an exit curb type, an intersection curb type, or standard undecided curb type. An exit curb type is assigned a strong confidence score (e.g., value), e.g., 10. An intersection curb type is assigned a medium confidence score, e.g., 5. A standard or undecided curb type is assigned a low confidence score, e.g., 1.

The processor 106 combines (block 734) or aggregates the results of each allocated confidence score determined from the detected curb types generated by the plausibility check 726. If the confidence score is high (block 736) and above a predetermined threshold, the ADV 102 will park 738 and activate the brake 110 and stop (block 740). The predetermined threshold can be a confidence score of 5 or higher. In another example, if the confidence score is 10 or greater and there is no detection of another vehicle parked within the vicinity of the ADV 102, the processor 106 will instruct the ADV 102 to park. If the confidence score is low (block 736) and below a predetermined threshold, the ADV 102 will continue driving 718.

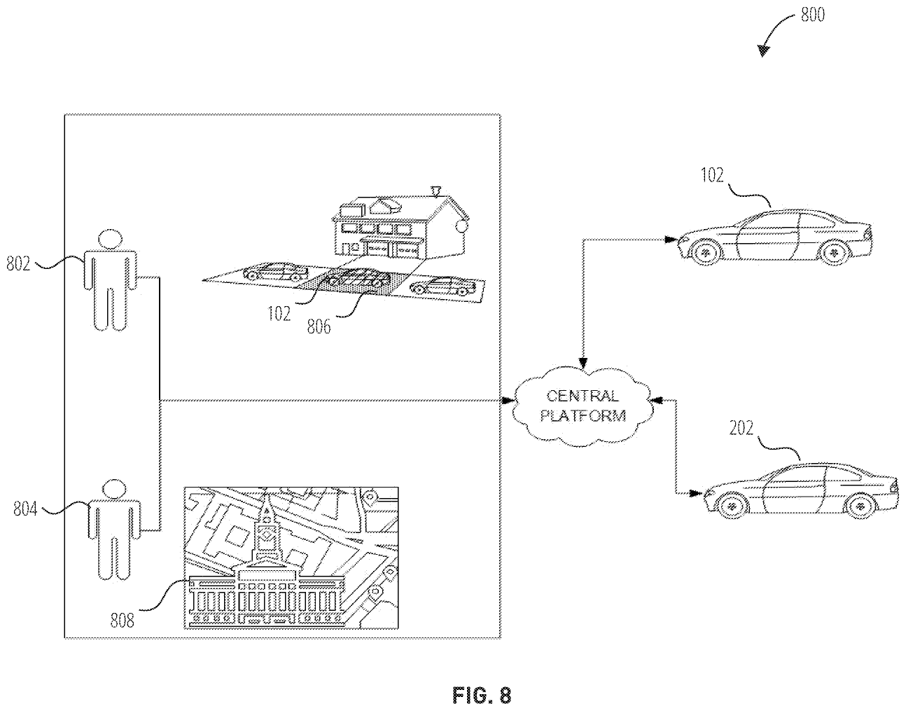

FIG. 8 is a diagrammatic representation of an automated driving vehicle and occlusion prevention subsystem using a centralized software platform, in accordance with some examples. As shown in FIG. 8, a user 802 dynamically manages parking spaces for autonomous vehicles by entering parking space occupancy data into the centralized software presenting the specified area, time, and location of parking spaces or empty spaces for both non-automated vehicle and automated vehicles. In one example shown in FIG. 8, the user 802 is a homeowner that manages the available parking space 806 in which the ADV 102 is currently parked into. The homeowner 802 input occupancy data representing the available parking space 806 (e.g., garage entrance) is available all day. The user 804 represents an Administrator of a municipality that manages the occupancy data stored in the municipality database 808. As the ADV 102 searches for available parking spaces via the centralized software platform, the approaching vehicle 202 may trigger in advance a request to free up available parking space 806 at any time or a predetermined period of time. The Administrator 804 of the municipality database 808 can also indicate available parking spaces stored and managed by a city, town, state, or municipality.

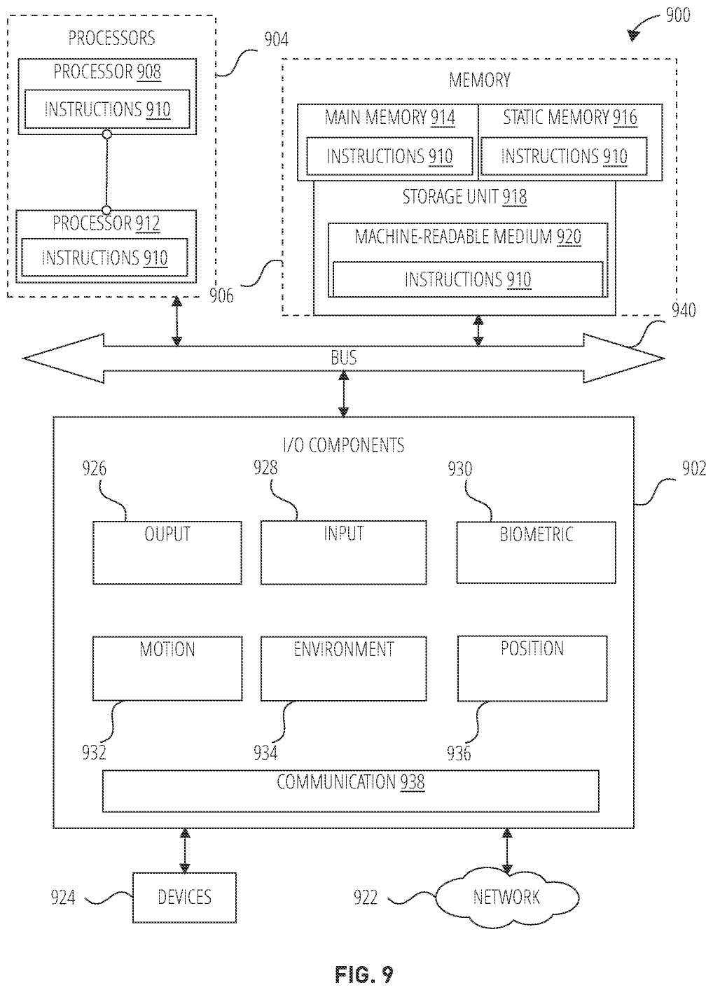

FIG. 9 is a diagrammatic representation of the machine 900 within which instructions 910 (e.g., software, a program, an application, an applet, an app, or other executable code) for causing the machine 900 to perform any one or more of the methodologies discussed herein may be executed. For example, the instructions 910 may cause the machine 900 to execute any one or more of the methods described herein. The instructions 910 transform the general, non-programmed machine 900 into a particular machine 900 programmed to carry out the described and illustrated functions in the manner described. The machine 900 may operate as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 910, sequentially or otherwise, that specify actions to be taken by the machine 900. Further, while only a single machine 900 is illustrated, the term “machine” shall also be taken to include a collection of machines that individually or jointly execute the instructions 910 to perform any one or more of the methodologies discussed herein.

The machine 900 may include processors 904, memory 906, and I/O components 902, which may be configured to communicate with each other via a bus 940. In an example embodiment, the processors 904 (e.g., a Central Processing Unit (CPU), a Reduced Instruction Set Computing (RISC) Processor, a Complex instruction Set Computing (CISC) Processor, a Graphics Processing Unit (GPU), a Digital Signal Processor (DSP), an ASIC, a Radio-Frequency Integrated Circuit (RFIC), another Processor, or any suitable combination thereof) may include, for example, a Processor 908 and a Processor 912 that execute the instructions 910. The term “Processor” is intended to include multi-core processors that may comprise two or more independent processors (sometimes referred to as “cores”) that may execute instructions contemporaneously. Although FIG. 9 shows multiple processors 904, the machine 900 may include a single Processor with a single core, a single Processor with multiple cores (e.g., a multi-core Processor), multiple processors with a single core, multiple processors with multiples cores, or any combination thereof.

The memory 906 includes a main memory 914, a static memory 916, and a storage unit 918, both accessible to the processors 904 via the bus 940. The main memory 906, the static memory 916, and storage unit 918 store the instructions 910 embodying any one or more of the methodologies or functions described herein. The instructions 910 may also reside, completely or partially, within the main memory 914, within the static memory 916, within machine-readable medium 920 within the storage unit 918, within at least one of the processors 904 (e.g., within the Processor's cache memory), or any suitable combination thereof, during execution thereof by the machine 900.

The I/O components 902 may include a wide variety of components to receive input, provide output, produce output, transmit information, exchange information, capture measurements, and so on. The specific I/O components 902 that are included in a particular machine will depend on the type of machine. For example, portable machines such as mobile phones may include a touch input device or other such input mechanisms, while a headless server machine will likely not include such a touch input device. It will be appreciated that the I/O components 902 may include many other components that are not shown in FIG. 9. In various example embodiments, the I/O components 902 may include output components 926 and input components 928. The output components 926 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 928 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 902 may include biometric components 930, motion components 932, environmental components 934, or position components 936, among a wide array of other components. For example, the biometric components 930 include components to detect expressions (e.g., hand expressions, facial expressions, vocal expressions, body gestures, or eye-tracking), measure bio signals (e.g., blood pressure, heart rate, body temperature, perspiration, or brain waves), identify a person (e.g., voice identification, retinal identification, facial identification, fingerprint identification, or electroencephalogram-based identification), and the like. The motion components 932 include acceleration sensor components (e.g., accelerometer), gravitation sensor components, rotation sensor components (e.g., gyroscope). The environmental components 934 include, for example, one or cameras, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 936 include location sensor components (e.g., a GPS receiver Component), altitude sensor components (e.g., altimeters or barometers that detect air pressure from which altitude may be derived), orientation sensor components (e.g., magnetometers), and the like.

Communication may be implemented using a wide variety of technologies. The I/O components 902 further include communication components 938 operable to couple the machine 900 to a network 922 or devices 924 via respective coupling or connections. For example, the communication components 938 may include a network interface Component or another suitable device to interface with the network 922. In further examples, the communication components 938 may include wired communication components, wireless communication components, cellular communication components, Near Field Communication (NFC) components, Bluetooth® components (e.g., Bluetooth® Low Energy). Wi-Fi® components, and other communication components to provide communication via other modalities. The devices 924 may be another machine or any of a wide variety of peripheral devices (e.g., a peripheral device coupled via a USB).

Moreover, the communication components 938 may detect identifiers or include components operable to detect identifiers. For example, the communication components 938 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code. Data Matrix, Data glyph, Maxi Code. PDF417. Ultra Code. UCC RSS-2D bar code, and other optical codes), or acoustic detection components (e.g., microphones to identify tagged audio signals). In addition, a variety of information may be derived via the communication components 938, such as location via Internet Protocol (IP) geolocation, location via Wi-Fi® signal triangulation, location via detecting an NFC beacon signal that may indicate a particular location, and so forth.

The various memories (e.g., main memory 914, static memory 916, and/or memory of the processors 904) and/or storage unit 918 may store one or more sets of instructions and data structures (e.g., software) embodying or used by any one or more of the methodologies or functions described herein. These instructions (e.g., the instructions 910), when executed by processors 904, cause various operations to implement the disclosed embodiments.

The instructions 910 may be transmitted or received over the network 922, using a transmission medium, via a network interface device (e.g., a network interface Component included in the communication components 938) and using any one of several well-known transfer protocols (e.g., hypertext transfer protocol (HTTP)). Similarly, the instructions 910 may be transmitted or received using a transmission medium via a coupling (e.g., a peer-to-peer coupling) to the devices 924.

### Additional Notes & Examples

Example 1 is a system for an automated driving vehicle, the system comprising: a processor; and a memory storing instructions that, when executed by the processor, configure the system to perform operations of the automated driving vehicle comprising: detecting an available space, the available space comprising a curb and a space dimension; detecting a roadway marker associated with the available space; determining that the available space is not a parking space based on the road marker and the space dimension; responsive to determining that the available space is not the parking space, guiding the automated driving vehicle to park in the available space; and responsive to guiding the automated driving vehicle to park in the available space, activating an occlusion prevention subsystem.

In Example 2, the subject matter of Example 1 includes, wherein responsive to guiding the automated driving vehicle into the available space and initiating the application of brakes with the braking force while in the available space, activating an occlusion prevention subsystem, the occlusion prevention subsystem configured to perform operations comprising: detecting a second object moving in a second direction toward the automated driving vehicle, the automated driving vehicle comprising a second heading pointing in a third direction opposite from the second direction; detecting a traffic indicator associated with the second object; and initiating an actuated force of acceleration of the automated driving vehicle and guiding the automated driving vehicle in the direction away from the available space based on the detected traffic indicator.

In Example 3, the subject matter of Example 1-2 includes, wherein the occlusion prevention subsystem is configured to perform operations further comprising: detecting a second object moving in a second direction toward the automated driving vehicle, the automated driving vehicle comprising a second heading pointing in a third direction opposite from the second direction; detecting a traffic indicator associated with the second object; and initiating an actuated force of acceleration of the automated driving vehicle and guiding the automated driving vehicle in the direction away from the available space based on the detected traffic indicator.

In Example 4, the subject matter of Examples 1-3 includes, wherein the traffic indicator comprises a predetermined speed of the second object, a turn signal associated with the second object, or a headlight flashing sequence emitted from the second object.

In Example 5, the subject matter of Examples 1-3 includes, wherein the occlusion prevention subsystem is configured to perform operations further comprising: detecting a third object moving in a forward direction toward the second heading of the automated driving vehicle; detecting a traffic trajectory associated with the third object; and initiating the actuated force of acceleration of the automated driving vehicle and guiding the automated driving vehicle away from the available space based on the detected traffic indicator.

In Example 6, the subject matter of Examples, 1-5 includes, wherein the traffic trajectory comprises a predetermined distance from third object and the automated driving vehicle, a turn signal associated with the third object, or a corridor angle trajectory.

In Example 7, the subject matter of Example 1-6, includes, wherein the guiding the automated driving vehicle comprises a first actuated force applied to an accelerator pedal of the automated driving vehicle.

In Example 8, the subject matter of Example 1-7, includes, wherein the initiating an application of brakes comprises applying a parking brake of the automated driving vehicle.

In Example 9, the subject matter of Examples 1-8, includes, wherein the braking force comprises a second actuated force applied to a braking pedal of the automated driving vehicle.

In Example 10, the subject matter of Examples 1-9, includes, wherein the space dimension comprises a width measurement, a depth measurement, and a length measurement of the available space.

In Example 11, the subject matter of Examples 1-10, includes, wherein the roadway marker comprises a road marking associated with a permissible available space.

In Example 12, the subject matter of Examples 1-11, includes, detecting a shape of a curb; determining a curb type based on the detected shape of the curb; detecting a plurality of structural characteristics within a proximity of the available space; determining that a moving object is not detected within a vicinity of the plurality of structural characteristics; and responsive to determining the curb type and that the moving object is not detected within the vicinity of the plurality of structural characteristics, guiding the automated driving vehicle to park into the available space.

In Example 13, the subject matter of Examples 1-12, includes, determining that the moving object is detected within a vicinity of the plurality of structural characteristics; and wherein responsive to determining that the curb type is less than the first confidence value, the plurality of structural characteristics is less than the second confidence value, and the moving object is detected within the vicinity of the plurality of structural characteristics, guiding the automated driving vehicle in a direction away from the available space.

In Example 14, the subject matter of Examples 1-13, includes, wherein the corridor angle trajectory comprises a turning diameter orthogonal to a 90 degree angle associated with the automated driving vehicle.

In Example 15 is a system for an automated driving vehicle, the system comprising: detecting an available space, the available space comprising available space characteristics; transmitting the available space characteristics to a computing device; receiving available space occupancy data, from the computing device, based on the available space characteristics; determining, based on the space occupancy data, that the available space is unavailable; responsive to determining that the available space is unavailable, guiding the automated driving vehicle in a direction away from the available space.

In Example 16, the subject matter of Examples 15 includes, wherein the available space characteristics comprises a width measurement, a depth measurement, a length measurement of the available space, a location, or a time frame of space availability.

In Example 17, the subject matter of Example 15-16 includes, wherein the space occupancy data comprises a notification that the available space is unavailable or a notification that the available space is available.

Example 18 is a method for an automated driving vehicle, the method comprising: detecting an available space, the available space comprising a curb and a space dimension; detecting a roadway marker associated with the available space; determining that the available space is available based on the roadway marker and the space dimension; and responsive to determining that the available space is available based on the roadway marker and the space dimension, guiding the automated driving vehicle into the available space and initiating an application of brakes with a braking force.

In Example 19, the subject matter of Example 18 includes, wherein the guiding the automated driving vehicle comprises a first actuated force applied to an accelerator pedal of the automated driving vehicle.

In Example 20, the subject matter of Example 18-19 includes, wherein the initiating an application of brakes comprises applying a parking brake of the automated driving vehicle.

In Example 21, the subject matter of Example 18-20 includes, wherein the braking force comprises a second actuated force applied to a braking pedal of the automated driving vehicle.

In Example 22, the subject matter of Example 18-21 includes, wherein the space dimension comprises a width measurement, a depth measurement, and a length measurement of the available space.

In Example 23, the subject matter of Example 18-22 includes, wherein the roadway marker comprises a road marking associated with a permissible available space.

In Example 24, the subject matter of Example 18-23 includes, detecting a shape of the curb; determining a curb type based on the detected shape of the curb; detecting a plurality of structural characteristics within a proximity of the available space; determining that a moving object is not detected within a vicinity of the plurality of structural characteristics; determining that the curb type is below a first threshold value; determining that the plurality of structural characteristics exceed a second threshold value; responsive to determining that the curb type is below the first threshold value, the plurality of structural characteristics exceed the second threshold value, and the moving object is not detected within the vicinity of the plurality of structural characteristics, guiding the automated driving vehicle into the available space; and initiating the application of brakes with the braking force while in the available space.

Example 25 is a non-transitory computer-readable storage medium, the computer-readable storage medium including instructions that when executed by a computer, cause the computer to perform operations comprising, detecting an available space, the available space comprising a curb and a space dimension; detecting a roadway marker associated with the available space; determining that the available space is available based on the roadway marker and the space dimension; and responsive to determining that the available space is available based on the roadway marker and the space dimension, guiding the automated driving vehicle into the available space and initiating an application of brakes with a braking force.

What is claimed is:

1. A system for an automated driving vehicle, the system comprising:
a processor; and
a memory storing instructions that, when executed by the processor, configure the system to perform operations of the automated driving vehicle comprising:
detecting an available space, the available space comprising a space dimension larger than the automated driving vehicle;
detecting a road marker associated with the available space;
determining that the available space is not a parking space based on the road marker and the space dimension;
responsive to determining that the available space is not the parking space, guiding the automated driving vehicle to park in the available space; and
responsive to guiding the automated driving vehicle to park in the available space, activating an occlusion prevention subsystem.

2. The system of claim 1, wherein the activating the occlusion prevention subsystem further comprises:
detecting a moving object in a first direction toward the automated driving vehicle, the moving object comprising a first heading;
determining that the heading of the moving object is pointing in the first direction toward the automated driving vehicle;
determining a distance between the moving object and the automated driving vehicle;
determining that the distance between the moving object and the automated driving vehicle is less than a first threshold value; and
responsive to the heading of the moving object pointing in the first direction and determining that the distance between the object and the automated driving vehicle is less than the first threshold value, initiating an actuated force of acceleration of the automated driving vehicle and guiding the automated driving vehicle in the direction away from the available space.

3. The system of claim 2, wherein the occlusion prevention subsystem is configured to perform operations further comprising:
detecting a second moving object moving in a second direction toward the automated driving vehicle, the automated driving vehicle comprising a second heading pointing in a third direction opposite from the second direction;
detecting a traffic indicator associated with the second moving object; and
initiating an actuated force of acceleration of the automated driving vehicle and guiding the automated driving vehicle in the direction away from the parking space based on the detected traffic indicator.

4. The system of claim 3, wherein the traffic indicator comprises at least one of a predetermined speed of the second object, a turn signal associated with the second object, or a headlight flashing sequence emitted from the second object.

5. The system of claim 3, wherein the occlusion prevention subsystem is configured to perform operations further comprising:
detecting a third moving object moving in a forward direction toward the second heading of the automated driving vehicle;
detecting a traffic trajectory associated with the third moving object; and
initiating the actuated force of acceleration of the automated driving vehicle and guiding the automated driving vehicle away from the available space based on the detected traffic indicator.

6. The system of claim 5, wherein the traffic trajectory comprises at least one of a predetermined distance from a third object and the automated driving vehicle, a turn signal associated with the third moving object, or a corridor angle trajectory.

7. The system of claim 1, wherein the guiding the automated driving vehicle comprises a first actuated force applied to an accelerator pedal of the automated driving vehicle.

8. The system of claim 1, wherein the initiating an application of brakes comprises applying a parking brake of the automated driving vehicle.

9. The system of claim 1, wherein the braking force comprises a second actuated force applied to a braking pedal of the automated driving vehicle.

10. The system of claim 1, wherein the space dimension comprises at least one of a width measurement, a depth measurement, and a length measurement of the available space.

11. The system of claim 1, wherein the roadway marker comprises a road marking associated with a permissible available space.

12. The system of claim 1, further comprising:
detecting a shape of a curb;
determining a curb type based on the detected shape of the curb;
detecting a plurality of structural characteristics within a proximity of the available space;
determining that a moving object is not detected within a vicinity of the plurality of structural characteristics; and
responsive to determining the curb type and that the moving object is not detected within the vicinity of the plurality of structural characteristics, guiding the automated driving vehicle to park into the available space.

13. The system of claim 12, further comprising:
determining that the moving object is detected within a vicinity of the plurality of structural characteristics; and
wherein responsive to determining that the moving object is detected within the vicinity of the plurality of structural characteristics, guiding the automated driving vehicle in a direction away from the available space.

14. The system of claim 6, wherein the corridor angle trajectory comprises a turning diameter orthogonal to a 90 degree angle associated with the automated driving vehicle.

15. A system for an automated driving vehicle, the system comprising:
a processor; and
a memory storing instructions that, when executed by the processor, configure the system to perform operations of the automated driving vehicle comprising:
detecting an available space, the available space comprising parking space characteristics;
transmitting the parking space characteristics to a computing device;
receiving available space occupancy data, from the computing device, based on the parking space characteristics;
determining that the available space is not a parking space based on the available space occupancy data;
responsive to determining that the available space is not the parking space, guiding the automated driving vehicle to park in the available space; and
responsive to guiding the automated driving vehicle to park in the available space, activating an occlusion prevention subsystem.

16. The system of claim 15, wherein the parking space characteristics comprises at least one of a width measurement, a depth measurement, a length measurement of the parking space, a location, or a time frame of space availability.

17. The system of claim 15, wherein the space occupancy data comprises a notification that the available space is unavailable or a notification that the available space is available.

18. A method for an automated driving vehicle comprising, detecting an available space, the available space comprising a space dimension larger than the automated driving vehicle;
detecting a road marker associated with the available space;
determining that the available space is not a parking space based on the road marker and the space dimension;
responsive to determining that the available space is not the parking space, guiding the automated driving vehicle to park in the available space; and
responsive to guiding the automated driving vehicle to park in the available space, activating an occlusion prevention subsystem.

19. The method of claim 18, wherein the guiding the automated driving vehicle comprises a first actuated force applied to an accelerator pedal of the automated driving vehicle.

20. The method of claim 18, wherein the initiating an application of brakes comprises applying a parking brake of the automated driving vehicle.

21. The method of claim 18, wherein the braking force comprises a second actuated force applied to a braking pedal of the automated driving vehicle.

22. The method of claim 18, wherein the roadway marker comprises a road marking associated with a permissible available space.

23. The method of claim 18, wherein in response to determining that the available space is unavailable,
detecting a shape of a curb;
determining a curb type based on the detected shape of the curb;
detecting a plurality of structural characteristics within a proximity of the available space;
determining that a moving object is not detected within a vicinity of the plurality of structural characteristics; and
responsive to determining the curb type and that the moving object is not detected within the vicinity of the plurality of structural characteristics, guiding the automated driving vehicle to park into the available space.

24. At least one non-transitory computer-readable storage medium, the computer-readable storage medium including instructions that when executed by a computer, cause the computer to perform operations comprising,
detecting an available space, the available space comprising a space dimension larger than the automated driving vehicle;
determining that the available space is not a parking space based on the road marker and the space dimension;
responsive to determining that the available space is not the parking space, guiding the automated driving vehicle to park in the available space; and
responsive to guiding the automated driving vehicle to park in the available space, activating an occlusion prevention subsystem.

25. At least one of the non-transitory computer-readable storage medium of claim 24, wherein the space dimension comprises a width measurement, a depth measurement, and a length measurement of the available space.
